(19) United States
(12) Patent Application Publication
(10) Pub. No.: US 2011/0284042 A1
(43) Pub. Date: Nov. 24, 2011

(54) DECONTAMINATION DEVICE WITH REGULATION BY AIR LEAK

(76) Inventor: Frederic Goessens, Vieillevigne (FR)

(21) Appl. No.: 13/147,260

(22) PCT Filed: Feb. 3, 2010
(86) PCT No.: PCT/FR2010/000079

§ 371 Date: Aug. 1, 2011

(30) Foreign Application Priority Data
Feb. 4, 2009 (FR) 0900472

(51) Int. Cl. B08B 3/00

(52) U.S. Cl. 134/198

(57) ABSTRACT

The present invention relates to a decontamination device of the type comprising a compressor (1) supplying pressurized gas, with interposition of means of pressure regulation, means (5) suited for misting a decontamination product in the form of fine droplets in a room to be treated. This device is characterized in that the compressor (1) directly supplies the means of misting (5) at a desired pressure for use, and without interposition of a buffer tank, where the means of pressure regulation (11) are constituted by a controlled flow rate leak between the outlet (S) of the compressor (1) and the inlet (E) of the means of misting (5).

The present invention relates to a decontamination device by misting of the type suited to generating and propelling fine droplets of a treatment product into a room to be treated forming therein a mist of the type referred to as “dry mist”.

It is known that bacterial agents which are the cause of contamination and which are suspended in the air in a room have a tendency to settle onto the various surfaces and objects contained therein. It is further known that inversely bacterial agents which develop on the objects and walls in a room (for example operating rooms, clean rooms or various care rooms, etc.) have a tendency to go into suspension in the atmosphere. These rooms are therefore found in a situation of continual exchange between the walls and objects on the one hand and the atmosphere on the other.

Ensuring the overall decontamination, meaning both the atmosphere and various walls and objects of a room, is proposed by spraying a disinfecting product into the volume thereof. It has been observed this kind of disinfection by spraying has several drawbacks.

First, the size of the droplets formed is relatively large (of order 80 to 200 μm for flow rate of 3 to 5 mL of air per minute), such that droplets deposit on the surfaces near the site of their spraying by simple force of gravity, which of course is not satisfactory to the extent where the surfaces far from the spraying injector go untreated.

Second, because of the large size of the droplets, they have a tendency to combine and form a damp film, even liquid pools, on the surfaces of the walls and objects in the room.

In the patent FR 2,859,650 in the name of the applicant, improving the fractionating of the spray droplets was proposed by making use of an injection device making it possible to obtain fine droplets whose dimensions are of order 2 μm to 20 μm and which thus have the property of being found in suspension in the entire volume of the room and depositing on the walls and objects contained therein without clumping together so well that they form a continuous film; the mist thus generated is called “dry mist”.

According to a particularly interesting variant of this invention, the injection device is provided with an ultrasonic “resonator” placed downstream from the injector outlet, such that the flow exiting therefrom finds itself subject to a fragmentation forming a sort of “diffraction” of the drops, having the effect of making them still smaller which makes it possible to further increase the homogeneity of their distribution.

In the patent application FR 09.000134 the applicant has also proposed an injector enabling ensuring an even finer fractionating of the droplets sprayed in the room.

The decontamination devices suited to performing this type of misting are typically made up of a compressor in particular an oil-lubricated type compressor, which supplies the buffer reservoir from which, by the intermediary of means of pressure regulation, an injector device is supplied. Devices of this type have notable disadvantages.

First, the storage of pressurized air in the buffer reservoir has the effect of generating condensates because of the various temperature and pressure fluctuations to which the air is subjected during the process.

The user of this type of device is therefore constrained to regularly remove the condensates from the storage reservoir and dispose thereof. For the same reasons, the air at the outlet of the reservoir passes through a filter which must itself be provided with means for purging which must be emptied regularly.

Further, it is known that reservoirs intended to receive pressurized gases are subject to safety standards which constrain the user to periodically have them inspected which of course causes the user constraint and inconvenience in the operation of the device. Further at the national level the applicable standards are sometimes very different from one country to another which makes the manufacturer exporting these devices design different storage reservoirs from one country to another thus increasing the management complexity and also the cost for these devices.

Furthermore, just the existence of these buffer reservoirs imposes a significant volume and weight on these decontamination devices along with a specific cost which also increases their production cost.

Finally it is known that for it to be possible to have a given pressure, notably of order 3×10⁵ Pa at the outlet of the buffer reservoir, downstream from the means of regulation, the reservoir for its part to be supplied under a pressure included between two and three times that pressure, i.e. between 7×10⁵ Pa and 10×10⁵ Pa, which is a source of both energy consumption and repeated mechanical stresses leading to fatigue of the storage reservoir and the accessories thereof.

The purpose of the present invention is to propose a new type of decontamination devices which are free from the aforementioned disadvantages.

Thus the purpose of the present invention is a decontamination device of the type comprising a compressor supplying pressurized gas, with interposition of means of pressure regulation, and means suited for misting a decontamination product in the form of fine droplets in a room to be treated, characterized in that the compressor directly supplies a desired pressure for use to the means for misting without interposition of a buffer reservoir, where the means of pressure regulation are constituted by a controlled flow rate leak between the outlet of the compressor and the inlet of the misting means.

Preferably the device according to the invention will comprise means for control of the flow-rate leak such that it will become active as soon as the pressure at the inlet of the means of misting exceeds the desired usage pressure and the compressor will be of the continuously operating type.

Additionally, in order to minimize the ambient pollution, the compressor will be of the oil-free lubrication type.

In an embodiment of the present invention, the means of pressure regulation could be constituted of a mechanical regulating valve formed of a body provided with an inlet line and an outlet line to free air for which the connection is controlled by a valve reed applied, in non-connecting position, onto a seat by a spring calibrated to a compression value near the recommended pressure.

The means of pressure regulation could also be electronic type and include pressure measurement means placed in branches on the main line connecting the compressor to the misting means, which will be connected to electronic analysis and control means, in particular a microcontroller driven by an appropriate program. This microcontroller will provide the control, in particular electronic control, of a valve mounted in a branch on the main line, so as to order the opening thereof when the pressure therein exceeds the recommended pressure.

Preferably the means of pressure regulation will be suited to generate a leak whose flow rate will be larger when the pressure difference between the recommended pressure and the compressor outlet pressure will be larger.

In the decontamination device according to the invention, the outlet pressure from the compressor could be equal to the nominal value of 3×10⁵ Pa. This lower pressure provides it notable advantages and in particular a substantial energy savings and an optimization of the lifetime of the compressor.

As a nonlimiting example, an embodiment of the present invention will be described below with reference to the attached drawing in which:

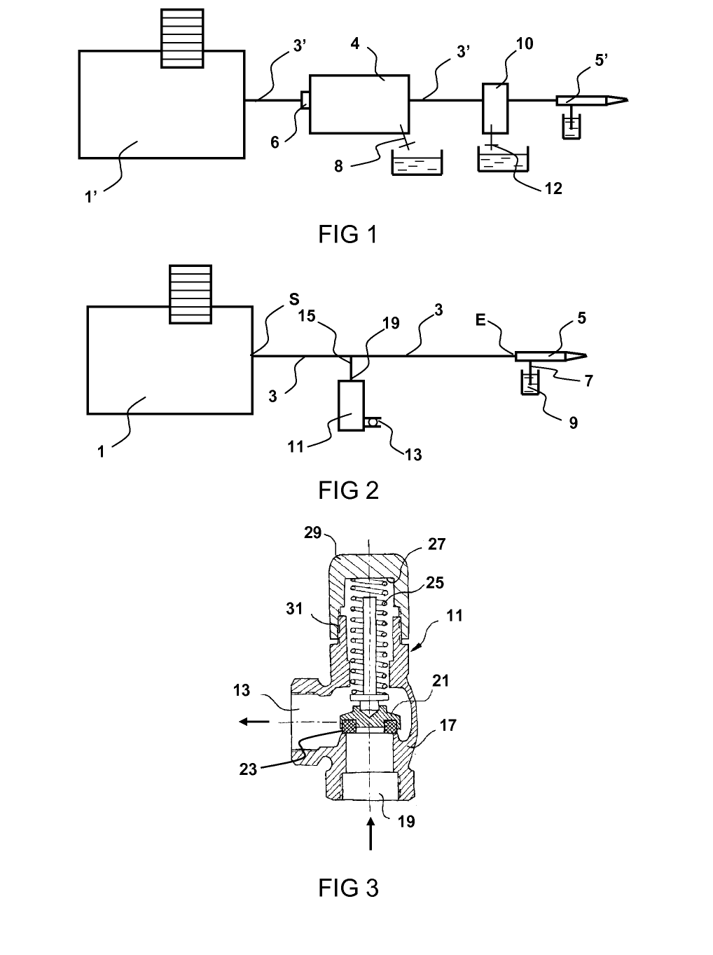

FIG. 1 is a schematic view of a decontamination device according to the prior art.

FIG. 2 is a schematic view of a decontamination device according to the invention.

FIG. 3 is a schematic sectional view of an example of a mechanical pressure-regulating valve implemented in the decontamination device according to the invention.

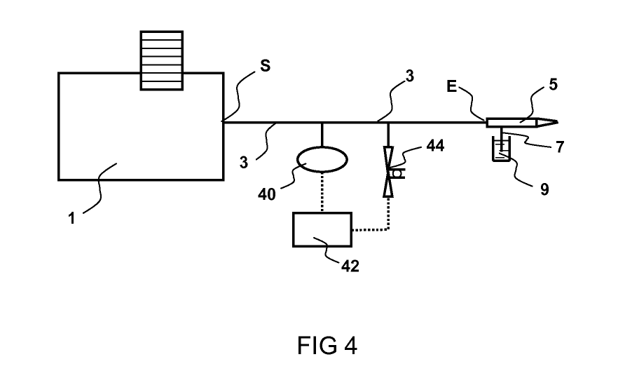

FIG. 4 is a schematic view of the variant of the device suited for creating a pressure regulating leak in a decontamination device according to the invention.

FIG. 1 shows a decontamination device of the type conforming to the prior art, which is intended to spray by misting by means of an injector 5′ a decontamination product in the form of fine droplets into the volume of a room to be treated.

This device includes a non-continuous operation type compressor 1′, meaning it is designed to operate intermittently. Through line 3′ this compressor supplies a buffer reservoir 4 with interposition of a pressostat-type control device 6 which allows filling the reservoir 4 with air and stops it once the pressure reaches a maximum level, for example 10×10⁵ Pa and reactivates the compressor 1′ once the pressure drops below a minimum threshold, for example 7×10⁵ Pa. It is understood that the pressure and temperature fluctuations to which the air in the reservoir 4 is subject lead to the creation of condensates which are eliminated by means of a drain tap 8 provided on the reservoir 4.

Means of filtration 10 are provided at the outlet thereof, and these means of filtration comprise a purge 12 also making it possible to collect the condensates.

FIG. 2 shows schematically a decontamination device according to the invention. This device includes compressor 1 of the type suited to operate continuously, whose outlet S is connected by line 3 to an injector 5 which comprises means of aspiration 7, by Venturi effect, of the treatment liquid contained in the storage cartridge 9. According to the invention, the means of pressure regulation for misting at the outlet of compressor 1 are constituted of a mechanical regulating valve 11 on a branch 15 which is tapped on the line 3 where the valve outlet 13 is connected with the atmosphere.

An example of a mechanical regulating valve 11 is shown in schematic form in FIG. 3. It is constituted of a body 17 which is hollowed for an air inlet line 19 which is stopped by a valve reed 21 placed in closed position on a valve reed seat 23 under the action of a compression spring 25, and an outlet 13 which is connected with the atmosphere. For this purpose, the spring 25, at one end thereof, rests on the valve reed 21, and at the other end thereof, on the bottom 27 of a bell-shaped adjustment nut 29 which is screwed on a threading 31 on the body 17.

It is understood that by screwing the nut 29 more or less, the spring 25 is compressed more or less and therefore the valve reed 21 is pressed with a greater or lesser force on the valve reed seat 23.

The inlet 19 of the mechanical regulating valve 11 is connected to the outlet S of the compressor 1 and also to the inlet E of the injector 5 by the pipe 3. The stiffness of the spring 25 is chosen such that, after adjustment of the compression thereof by means of the nut 29, the valve reed 21 is pushed back by the pressure of the incident air against the pressing force of the spring 25 once the intake pressure exceeds the value of the pressure for use Pu desired as pressure at the inlet of the injector, or recommended pressure, specifically, in the present example of implementation of the invention, 3×10⁵ Pa. The admitted air then exits towards the outside by the outlet 13, such that a leak is thereby created and continues until the pressure drops to its nominal value P with the valve reed 21 then returning to the contact position thereof with the seat 23.

The present device thus makes it possible to regulate the air pressure admitted into the injector 5 and does so without making use of a storage reservoir which other than the cost, bulk and weight problems is additionally the source of various difficulties and disorders in the prior art decontamination devices which have been brought up previously.

Of course, according to the invention, the controlled leak necessary for regulation could also be created by any other means and in particular by making use of electronic means.

Thus, as shown in FIG. 4, a pressure sensor 40 could be placed on a branch on line 3 connecting the outlet S of the compressor 1 to inlet E of the injector 5 with the sensor connected to electronic control means, such as for example a microcontroller 42, where it is interfaced with electronic valve 44 whose opening is not all or nothing but instead would be adjustable progressively as a function of the control signals sent by the microcontrollers 42.

Under these conditions the microcontrollers 42 would be programmed to continuously compare the actual pressure value existing in the line 3 to the recommended pressure value P. As soon as the pressure in line 3 were to exceed this set pressure value, the microcontroller 42 would command valve 44 to open and this opening would be larger when the size of the pressure difference were larger.

1. A decontamination device of the type comprising a compressor (1) supplying pressurized gas, with interposition of means of pressure regulation, and means (5) suited for misting a decontamination product in the form of fine droplets in a room to be treated, characterized in that the compressor (1) directly supplies a desired pressure for use (Pu) to the means for misting without interposition of a buffer reservoir, where the means of pressure regulation (11) are constituted by a controlled flow rate leak between the outlet (S) of the compressor (1) and the inlet (E) of the misting means (5).

2. Decontamination device according to claim 1 characterized in that it comprises means for control (11) of the flow-rate leak such that it will become active as soon as the pressure at the inlet of the means of misting (5) exceeds the desired pressure of use (Pu).

3. Decontamination device according to one of claim 1 or 2 characterized in that the desired pressure of use (Pu) is of order 3×105 Pa.

4. Decontamination device according to one of the preceding claims characterized in that the compressor (1) is of the continuously operating type.

5. Decontamination device according to one of the preceding claims characterized in that the compressor (1) is of the oil-free lubrication type.

6. Decontamination device according to one of the preceding claims characterized in that the pressure regulation means are constituted of a mechanical regulation valve (11) formed of a body (17) provided with an inlet line (19) and an outlet line (13) to free air for which the connection is controlled by a valve reed (21) applied, in non-connecting position, onto a seat (23) by a spring (25) calibrated to a compression value near the recommended pressure (P).

7. Decontamination device according to one of claims 1 to 5 characterized in that the means of pressure regulation include pressure measurement means (40) placed in branches on the main line (3) connecting the compressor (1) outlet (S) to the inlet (E) of the misting means (5), which are connected to electronic analysis and control means (42) suited to control a valve (44) mounted in a branch on said main line (3), so as to activate the opening thereof when the pressure in the main line (3) exceeds the recommended pressure (P).

8. Decontamination device according to claim 7 characterized in that the electronic means are constituted by a microcontroller (42).

9. Decontamination device according to one of the preceding claims characterized in that means of pressure regulation are suited to generate a leak whose flow rate is larger when the pressure difference between the recommended pressure (P) and the compressor outlet pressure (1) is larger.
